(19) United States
(12) Patent Application Publication
(10) Pub. No.: US 2016/0020456 A1
(43) Pub. Date: Jan. 21, 2016

(54) CATHODE MATERIAL FOR NON-AQUEOUS LITHIUM SECONDARY BATTERY USING SPHERICAL COBALT HYDROXIDE

(71) Applicant: KOREA ELECTRONICS TECHNOLOGY INSTITUTE, Seongnam-si, Gyeonggi-do (KR)

(72) Inventors: Junho SONG, Seongnam-si, Gyeonggi-do (KR); Woosuk CHO, Namyangju-si, Gyeonggi-do (KR); Dongjin KIM, Namyangju-si, Gyeonggi-do (KR); Yeonhee KIM, Seoul (KR); Youngjun KIM, Yongin-si, Gyeonggi-do (KR)

(73) Assignee: Korea Electronics Technology Inststute

(21) Appl. No.: 14/395,451

(22) PCT Filed: Mar. 4, 2013
(86) PCT No.: PCT/KR2013/001692

§ 371 Date: Oct. 17, 2014

(30) Foreign Application Priority Data
Apr. 19, 2012 (KR) 10-2012-0040756
Aug. 30, 2012 (KR) 10-2012-0095402

(51) Int. Cl. H01M 4/131; C01G 51/00; H01M 4/04; H01M 4/525

(52) U.S. Cl. CPC H01M 4/131; H01M 4/525; C01G 51/42; H01M 4/0471; H01M 4/0497; H01M 2004/028

(57) ABSTRACT

The present invention relates to a cathode material for a nonaqueous lithium secondary battery using spherical cobalt hydroxide to inhibit the structural collapse of a final cathode material at a high voltage by preparing spherical cobalt hydroxide in which a dissimilar metal is uniformly substituted by using a precipitation reaction in a liquid phase, thereby improving lifetime characteristics even under high voltage charge/discharge conditions of 4.5 V. According to the present invention, it is possible to prepare spherical cobalt hydroxide having a particle size of 15-30 μm by precipitating a cobalt material, a hydroxyl group material, a dissimilar metal material for substitution and an amine-based material so as to have a composition represented by Co1-xMx(OH)2 (0.00≦x≦0.10, M=Al, Mg, Ti, and the like). Also, it is possible to prepare spherical cobalt oxide having a particle size of 10-25 μm by heat-treating the prepared cobalt hydroxide at 500-800° C.

### CROSS-REFERENCE TO RELATED APPLICATION

This application claims the priority of Korean Patent Application No. 10-2012-0040756, filed on Apr. 19, 2012 in the Korean Intellectual Property Office and Korean Patent Application No. 10-2012-0095402 filed on Aug. 30, 2012 in the Korean Intellectual Property Office. Further, this application is the National Phase application of International Application No. PCT/KR2013/001692 filed on Mar. 4, 2013, which is incorporated herein by reference in its entirety.

### TECHNICAL FIELD

The present invention relates to a non-aqueous cathode material for a lithium secondary battery, and more particularly, to a non-aqueous cathode material for a lithium secondary battery using spherical cobalt hydroxide which can minimize a side reaction with an electrolyte even when used at a high voltage since a functional complex agent is used, thereby having a very high degree of sphericity.

### BACKGROUND

New secondary batteries including a nickel hydrogen battery and a lithium secondary battery are being actively developed as portable small electrical and electronic devices are spreading. Among these batteries, the lithium secondary battery is a battery using carbon such as graphite as an anode active material, an oxide including lithium as a cathode active material, and a non-aqueous solvent as an electrolyte. Since lithium is a metal having a very high tendency toward ionization, high voltage expression is possible and therefore a battery having a high energy density is being developed.

As the cathode active material, a lithium transition metal oxide containing lithium is generally used, and 90% or more of layered lithium transition metal oxides which contain cobalt, nickel, and three elements including cobalt, nickel and manganese are used. However, the layered lithium transition metal oxide widely used as the cathode active material causes unusual behavior such as decreases in capacity and power since cobalt ions are eluted due to a side reaction with an electrolyte in non-ideal states (overcharging and a high temperature), or an irreversible resistant layer is formed on a surface. Due to such disadvantages of the layered lithium metal oxide, a study for inhibiting a side effect with an electrolyte is progressing by minimizing a specific surface area from a process of preparing a precursor to overcome the disadvantages and to be used for a long time.

### SUMMARY

To solve such a problem, it was intended to prepare a cathode material having a large particle size to minimize a side reaction with an electrolyte and enhance lifetime characteristics. However, due to characteristics of the layered material, when particles are coarse, planar growth was stimulated, and therefore a specific surface area was not effectively reduced.

Accordingly, the present invention is directed to providing a non-aqueous cathode material for a lithium secondary battery using spherical cobalt hydroxide, which has a particle size of 20 μm or more to realize a high energy density and enhances the lifetime characteristics.

The present invention is also directed to providing a non-aqueous cathode material for a lithium secondary battery using spherical cobalt hydroxide, which has a remarkably excellent degree of sphericity and internal density, and is prepared by adding a functional complex agent to a process of preparing cobalt oxide in a liquid phase.

In one aspect, the present invention provides a non-aqueous cathode material for a lithium secondary battery, which includes spherical cobalt hydroxide prepared by coprecipitating an aqueous solution in which a cobalt material, a hydroxide group material, a dissimilar metal material for substitution and an amine-based material are mixed.

In the non-aqueous cathode material for a lithium secondary battery according to the present invention, the cobalt hydroxide may have a composition represented by Co₁₋ₓMₓ(OH)₂ (where 0.00≦x≦0.10, M=Al, Mg or Ti) and an average particle diameter of 15 to 30 μm.

In the non-aqueous cathode material for a lithium secondary battery according to the present invention, the cobalt hydroxide may be prepared by coprecipitating the cobalt material, the hydroxide group material, the dissimilar metal material for substitution and the amine-based material (each having a concentration of 0.5 to 2 M) in a ratio of 1:1.8 to 2.5:0.1 or less: 0.05 to 0.50, and the pH of the mixed aqueous solution is maintained at 10 to 12.

In the non-aqueous cathode material for a lithium secondary battery according to the present invention, the amine-based material may include ethylenediamine, urea or succinonitrile (SN).

In the non-aqueous cathode material for a lithium secondary battery according to the present invention, the cobalt material may include cobalt metal, manganese oxalate, manganese acetate, manganese nitrate or manganese sulfate. A dissimilar metal of the dissimilar metal material may include aluminum (Al), magnesium (Mg), or titanium (Ti).

In another aspect, the present invention provides a non-aqueous cathode material for a lithium secondary battery including dissimilar metal-substituted spherical cobalt oxide, which is prepared by preparing spherical cobalt hydroxide prepared by coprecipitating an aqueous solution in which a cobalt material, a hydroxide group material, a dissimilar metal material for substitution and an amine-based material are mixed, and thermally treating the cobalt hydroxide.

In the non-aqueous cathode material for a lithium secondary battery according to the present invention, the cobalt oxide may have a composition represented by Co_{3-y}M_{y}O₄ (where 0.00≦y≦0.30, M=Al, Mg or Ti) and an average particle diameter of 10 to 25 μm.

In the non-aqueous cathode material for a lithium secondary battery according to the present invention, the thermal treatment in the preparation of the cobalt oxide may be performed at 500 to 800° C.

In still another aspect, the present invention provides a non-aqueous cathode material for a lithium secondary battery including lithium cobalt oxide, which is prepared by preparing spherical cobalt hydroxide by coprecipitating an aqueous solution in which a cobalt material, a hydroxide group material, a dissimilar metal material for substitution and an amine-based material are mixed, preparing dissimilar metal-substituted spherical cobalt oxide by thermally treating the cobalt hydroxide, mixing a lithium material with the resulting cobalt hydroxide, and performing thermal treatment.

In the non-aqueous cathode material for a lithium secondary battery according to the present invention, the thermal treatment in the preparation of the cobalt oxide may be performed at 500 to 800° C., and the thermal treatment in the preparation of the lithium cobalt oxide may be performed at 900 to 1100° C.

In the non-aqueous cathode material for a lithium secondary battery according to the present invention, the lithium material may include lithium carbonate, lithium hydroxide, lithium acetate, lithium sulfate, lithium sulfite, lithium fluoride, lithium chloride, lithium bromide, or lithium iodide.

In yet another aspect, the present invention provides a non-aqueous cathode material for a lithium secondary battery, which has a composition represented by LiCo_{1-y}M_{y}O₂ (where 0.00≦y≦0.10, M=Al, Mg or Ti), is spherical, and has an average particle diameter of 15 to 25 μm.

According to the present invention, as high density cobalt hydroxide having a very high degree of sphericity to which dissimilar metal is uniformly substituted through a coprecipitation process using a functional complex agent including an amine-based material and cobalt oxide prepared through thermal treatment of the same are prepared, dissimilar metal-substituted lithium cobalt oxide prepared using the same can be prepared to have a high degree of sphericity, and a cathode material prepared as described above can be expressed to have a capacity of 80% or more of the initial capacity after charge/discharge 50 times at a high temperature of 60° C.

In addition, the cathode material according to the present invention can have a high degree of sphericity and a very small specific surface area, thereby considerably inhibiting a side reaction with an electrolyte at a high temperature.

### BRIEF DESCRIPTION OF DRAWINGS

FIG. 1 is a flow chart of a method of preparing a non-aqueous cathode material for a lithium secondary battery according to the present invention;

FIG. 2 is an image of an internal shape of spherical cobalt hydroxide of a non-aqueous cathode material for a lithium secondary battery prepared by the preparation method of Example 1 according to the preparation method of FIG. 1;

FIG. 3 is an image of an internal shape of spherical cobalt hydroxide, which is a non-aqueous cathode material for a lithium secondary battery prepared by a preparation method of Comparative Example 1;

FIG. 4 shows images of particle shapes of cobalt hydroxide, cobalt oxide and lithium cobalt oxide cathode materials prepared by the preparation method of Example 1;

FIG. 5 show images of particle shapes of cobalt hydroxide, cobalt oxide and lithium cobalt oxide cathode materials prepared by a preparation method of Example 2; and

FIG. 6 is a graph showing charge/discharge lifetime characteristics at a high temperature of 60° C. of the cathode materials prepared by the preparation methods of Examples 1 and 2 and Comparative Example 1.

### DETAILED DESCRIPTION

In the following descriptions, parts necessary for understanding examples of the present invention will be merely described, and it should be understood that descriptions of the other parts will be omitted without obscuring the substance of the present invention.

Terms and words used in the specification and claims described below should not be construed as a limitation to conventional or dictionary meanings, but should be interpreted as the meanings and concepts suitable for the technical spirit of the present invention on the principle that the inventor is able to properly define the terms and words to explain his own invention by the most appropriate method. Therefore, examples disclosed herein and the components illustrated in the drawings are merely exemplary embodiments of the present invention and do not represent all of the technical spirit of the present invention, and it should be understood that there can be various equivalents and modifications replacing them from the time of application.

Hereinafter, examples of the present invention will be described in further detail with reference to the accompanying drawings.

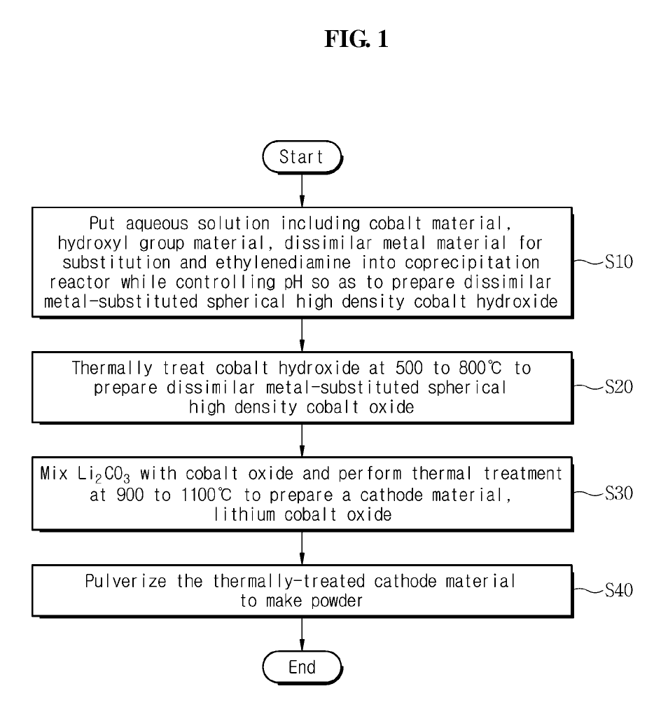

A method of preparing a non-aqueous cathode material for a lithium secondary battery according to the present invention will be described with reference to FIG. 1. Here, FIG. 1 is a flow chart of the method of preparing a non-aqueous cathode material for a lithium secondary battery according to the present invention.

Referring to FIG. 1, the method of preparing a non-aqueous cathode material for a lithium secondary battery according to the present invention includes preparing cobalt hydroxide (S10) and preparing cobalt oxide (S20), and further includes preparing lithium cobalt oxide (S30) and performing pulverization (S40). Here, in the preparation of cobalt hydroxide (S10), dissimilar metal-substituted spherical cobalt hydroxide is prepared by coprecipitating an aqueous solution in which a cobalt material, a hydroxide group material, a dissimilar metal material for substitution and an ethylenediamine material are mixed. Subsequently, dissimilar metal-substituted high density spherical cobalt oxide is prepared by thermally treating the cobalt hydroxide in the preparation of cobalt oxide (S20). Subsequently, lithium cobalt oxide is prepared by mixing lithium carbonate with the cobalt oxide and thermally treating the mixture in the preparation of lithium cobalt oxide (S30). Finally, in the pulverization (S40), a cathode material, the lithium cobalt oxide, is pulverized to make powder. The method of preparing a non-aqueous cathode material for a lithium secondary battery will be described in detail as follows.

First, in the preparation of cobalt hydroxide (S10), spherical cobalt hydroxide to which dissimilar metal is uniformly substituted according to Formula 1 is prepared by consistently putting a cobalt material, a hydroxide group material, a dissimilar metal material for substitution and an ethylenediamine material into a coprecipitation reactor while controlling pH. That is, cobalt hydroxide is prepared by reacting the materials each having a concentration for 0.5 to 2.0 M for 50 to 100 hours while being controlled to be in a ratio of a cobalt material:a dissimilar metal material for substitution:a hydroxide group material:an amine-based material=1:0.00 to 0.10:1.8 to 2.5:0.05 to 0.50. When the pH exceeds the above range of 10 to 12, uniform precipitation between cobalt and dissimilar metal may not occur and independent precipitation may occur, thus, a uniformly substituted hydroxide may not be obtained. In addition, when a reaction time is less than 50 hours, particles are formed relatively hard, thereby generating particles having a size of 5 μm or less, and therefore the particles are also spherized at a very low level.

Co₁₋ₓMₓ(OH)₂ [Formula 1]

(where 0.00≦x≦0.10, M=Al, Mg, Ti, etc)

Here, in the preparation of cobalt hydroxide (S10), spherical cobalt hydroxide having a particle size of 15 to 30 μm may be prepared by performing precipitation to have a composition represented by Formula 1.

The cobalt material includes at least one of cobalt metal, manganese oxalate, manganese acetate, manganese nitrate, and manganese sulfate, but the present invention is not limited thereto.

Dissimilar metal in the dissimilar metal material includes aluminum (Al), magnesium (Mg), and titanium (Ti). For example, when aluminum is used as the dissimilar metal, the dissimilar metal material includes, but is not limited to, at least one of aluminum nitrate and aluminum chloride.

In addition, the amine-based material may be, but is not limited to, ethylenediamine, urea and succinonitrile (SN).

Afterward, in the preparation of cobalt oxide (S20), cobalt oxide for a cathode material according to Formula 2 may be prepared by thermally treating the spherical cobalt hydroxide. Here, the final spherical cobalt oxide is prepared through thermal treatment in an air atmosphere at 500 to 800° C. Here, when thermal treatment is performed at 500° C. or less, sufficient thermal treatment with respect to a spherical precursor is not performed, and therefore 100% of the hydrogen ions may not be removed. However, when thermal treatment is performed at 800° C. or more, necessary reactions do not occur with respect to a spherical precursor, and thus a sphere is broken. When the sphere disappears, a reaction speed with a future lithium material is decreased, resulting in ineffectively preparing lithium cobalt oxide.

CO_{3-y}M_{y}O₄ [Formula 2]

(where 0.00≦y≦0.30, M=Al, Mg, Ti, etc)

The cobalt oxide prepared in the preparation of cobalt oxide (S20) is spherical cobalt oxide having a composition represented by Formula 2 and an average particle diameter of 10 to 25 μm. The cobalt oxide according to Formula 2 is a precursor for a cathode material according to the present invention prepared at the end.

In addition, a cathode material such as dissimilar metal-substituted lithium cobalt oxide may be prepared by reacting the cobalt oxide prepared in the preparation of lithium cobalt oxide (S30) with a lithium material. That is, a lithium cobalt oxide non-aqueous cathode material for a lithium secondary battery may be prepared by mixing a lithium material with the prepared cobalt oxide and performing thermal treatment.

LiCo_{1-y}M_{y}O₂ [Formula 3]

(where 0.00≦y≦0.10, M=Al, Mg or Ti)

The lithium cobalt oxide prepared in the preparation of lithium cobalt oxide (S30) is spherical lithium cobalt oxide having a composition represented by Formula 3, and an average particle diameter of 15 to 25 μm.

Here, the lithium material includes, but is not limited to, at least one of lithium carbonate, lithium hydroxide, lithium acetate, lithium sulfate, lithium sulfite, lithium fluoride, lithium chloride, lithium bromide, and lithium iodide.

Here, a final lithium cobalt oxide is prepared by performing thermal treatment in an air atmosphere at 900 to 1100° C. Here, when the thermal treatment is performed at 900° C. or less, the thermal treatment is not sufficiently done and thus an available capacity is decreased to 120 mAhg⁻¹ or less. Alternatively, when the thermal treatment is performed at 1100° C. or more, unnecessary reactions occur to generate macroparticles having a primary particle of 25 μm or more, and thus an output characteristic is degraded.

Meanwhile, to form a cathode plate after the preparation of lithium cobalt oxide (S30), the thermally-treated cathode material may be pulverized to make powder. Here, the pulverization is performed by a conventional method. As a pulverization means, for example, a mortar, a ball mill, a vibration mill, a satellite ball mill, a tube mill, a rod mill, a jet mill, or a hammer mill may be used, and when needed, a desired particle diameter distribution is obtained by a classification method. The average particle diameter of the powder of the cathode material of the present invention may be in a range of 15 to 25 μm.

The lithium secondary battery of the present invention to which the cathode material is applied has no difference from that manufactured by a conventional method, except the cathode material. The formation of the cathode plate and the components of the lithium secondary battery have been briefly described, but the present invention is not limited thereto.

The cathode plate is formed by adding a conductive agent, a binding agent, a filler, a dispersing agent, an ionic conductive agent, a pressure enhancer, and one or at least two conventionally used additional components to powder of the cathode material of the present invention when needed, to make a slurry or a paste using a suitable solvent (organic solvent), applying the slurry or paste obtained thereby to an electrode supporting substrate by a doctor-blade method, drying the resulting product, and pressing the dried product using a rolling roll.

The conductive agent is graphite, carbon black, acetylene black, Ketjen black, carbon fiber, or metal powder. The binding agent may be PVdF or polyethylene. The electrode supporting substrate (referred to as a collector) may be a film or sheet formed of copper, nickel, stainless steel or aluminum, or carbon fiber.

A lithium secondary battery is manufactured using the cathode formed as described above. A shape of the lithium secondary battery may be any one of a coin, a button, a sheet, a cylinder and a prism. An anode material, an electrolyte, and a separation film of the lithium secondary battery are the same as used in a conventional lithium secondary battery.

Here, the anode material may be one or at least two of carbon materials such as graphite and complex oxides of transition metal. In addition, silicon or tin may also be used as the anode material.

As the electrolyte, any one of a non-aqueous electrolyte prepared by dissolving a lithium salt in an organic solvent, an inorganic solid electrolyte, and a complex material of an inorganic solid electrolyte may be used.

As a solvent of the non-aqueous electrolyte, one or at least two of esters including ethylene carbonate, propylene carbonate, dimethyl carbonate, diethyl carbonate and methyl ethyl carbonate, lactones including butyl lactone, ethers including 1,2-dimethoxy ethane and ethoxy methoxy ethane, and nitriles including acetonitrile may be used.

As the lithium salt of the non-aqueous electrolyte, LiAsF₆, LiBF₄, or LiPF₆ may be used.

In addition, as the separation film, a porous film formed of a polyolefin such as PP and/or PE, or a porous material such as felt may be used.

### Examples and Comparative Examples

Cobalt oxide according to Example 1 was prepared as to be described below.

Dissimilar metal-substituted spherical cobalt hydroxide was prepared by putting 1.5 M of a cobalt sulfate solution, 1.5 M of a sodium hydroxide solution, a 1.5 M of aluminum nitrate solution, and 1.5 M of ethylenediamine solution into a coprecipitation reactor at a speed of 20 cc per hour in a ratio of 0.98:2.05:0.05:0.10 to perform a reaction for 80 hours or more. Final cobalt oxide for a cathode material according to Example 1 was prepared by maintaining the cobalt hydroxide prepared as described above in the air at 750° C. for 10 hours.

A final cathode material according to Example 1 was prepared by dry mixing lithium carbonate with the cobalt oxide prepared as described above to have a ratio of lithium ions to cobalt ions of 1.05 and maintaining the mixed result in the air at 950° C. for 15 hours.

Powder of the cathode material according to Example 1 was classified to have an average particle diameter of 15 to 25 μm. A slurry was prepared by dissolving 94 wt % of the cathode material, 3 wt % of acetylene black as a conductive agent and 3 wt % of PVdF as a binding agent in NMP as a solvent. An electrode was prepared in the shape of a disc having a diameter of 16 mm by coating the slurry to an Al foil to have a thickness of 20 μm, drying the coated product, compression milling the dried product using a press, and drying the compressed product in a vacuum at 120° C. for 16 hours.

A lithium metal film punched to have a diameter of 16 mm was used as a counter electrode, and as a separation film, a PP film was used. As an electrolyte, a mixed solution of 1M of LiPF₆ and EC/DME 1:1 v/v was used. The separation film was saturated with the electrolyte, the separation film was inserted between the action electrode and the counter electrode, and a case of an SUS product was evaluated as a test cell for evaluating an electrode.

The cathode materials according to Examples 2 and 3, and Comparative Examples 1 and 2 were prepared under conditions shown in Table 1.

TABLE 1

| | | | | | | | Lifetime charac- | |
|---|---|---|---|---|---|---|---|---|
| | | | | | | | teristics at 4.5 V | |
| | | | | | | Shape of | and 60° C. [%] | |
| | Input material (1.5M) | | | | | particle | (after charge/dis- | |
| Sample | Co | Substituting | | Ethylene | Ammonia | Co | charge 50 times) | Reference |
| ID | material | agent | NaOH | diamine | solution | material | Substituting agent | NaOH |
| 1 | 0.98 | 0.02 | 2.05 | 0.05 | 1 | 0.98 | 0.02 | 2.05 |
| 2 | 0.98 | 0.02 | 2.05 | 0.10 | 2 | 0.98 | 0.02 | 2.05 |
| 3 | 0.98 | 0.02 | 1.95 | 0.20 | 3 | 0.98 | 0.02 | 1.95 |
| 4 | 0.98 | 0.02 | 1.95 | 0.50 | 4 | 0.98 | 0.02 | 1.95 |
| 5 | 0.95 | 0.05 | 2.05 | 0.00 | 5 | 0.95 | 0.05 | 2.05 |

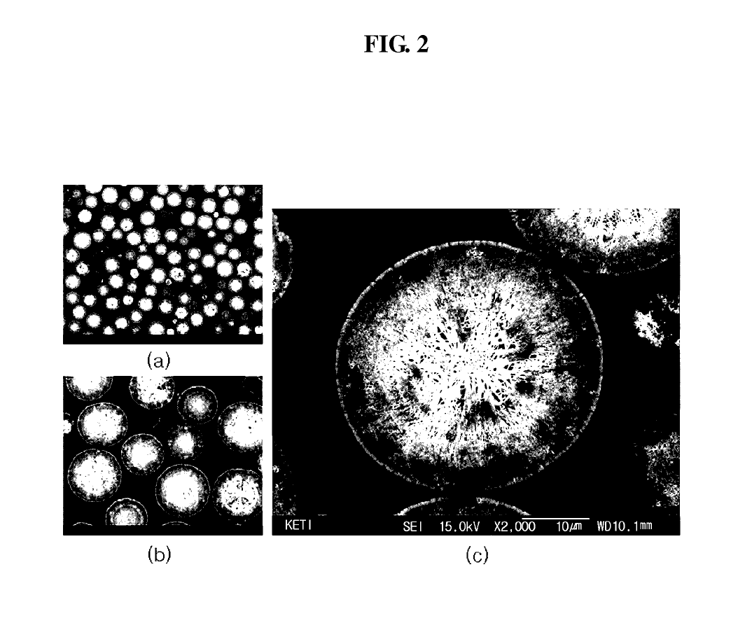

Internal shapes of the cathode materials prepared as described in Example 1 are shown in FIG. 2. FIG. 2 shows internal images of cobalt hydroxide, which is a precursor for the non-aqueous cathode material for a lithium secondary battery prepared by the preparation method of Example 1 shown in FIG. 1. From FIG. 2(a) to (c), the internal shape of the cobalt hydroxide is gradually enlarged.

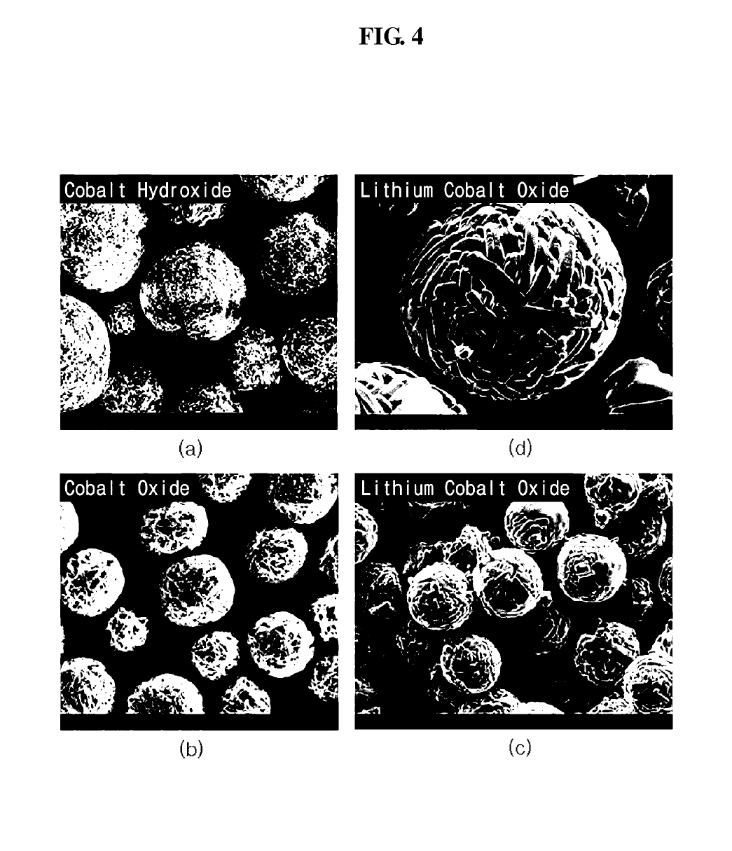

Referring to FIG. 2, since the cathode material has a very high degree of sphericity and relatively high density, a high density cathode material can be prepared by performing a reaction through thermal treatment with lithium carbonate. Such a high-level degree of sphericity can minimize a specific surface area, and provide chemical stability to the cathode material at a high temperature of 60° C. under charge/discharge conditions, thereby exhibiting excellent lifetime characteristics. In addition, images of the particle shapes of the cobalt hydroxide, cobalt oxide and lithium cobalt oxide cathode materials prepared by the preparation method of Example 1 are shown in FIG. 4. FIG. 4(d) is an enlarged image of FIG. 4(c).

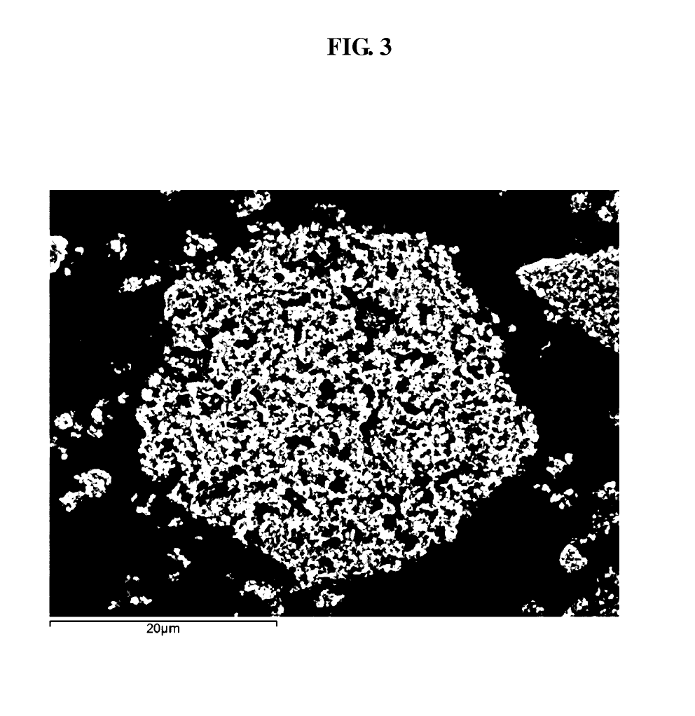

FIG. 3 shows internal shapes of cathode materials prepared according to the preparation method of Comparative Example 1. FIG. 3 shows images of an internal shape of cobalt hydroxide, which is a precursor for a non-aqueous cathode material for a lithium secondary battery prepared by a preparation method of Comparative Example 1. Since the cobalt hydroxide is spherical and has porosity, when a reaction is performed through thermal treatment with lithium carbonate to prepare a subsequent final cathode material, diffusion into cobalt oxide of a lithium kind is easily performed. However, in Comparative Example 1, compared to Example 1, density and a degree of sphericity are decreased.

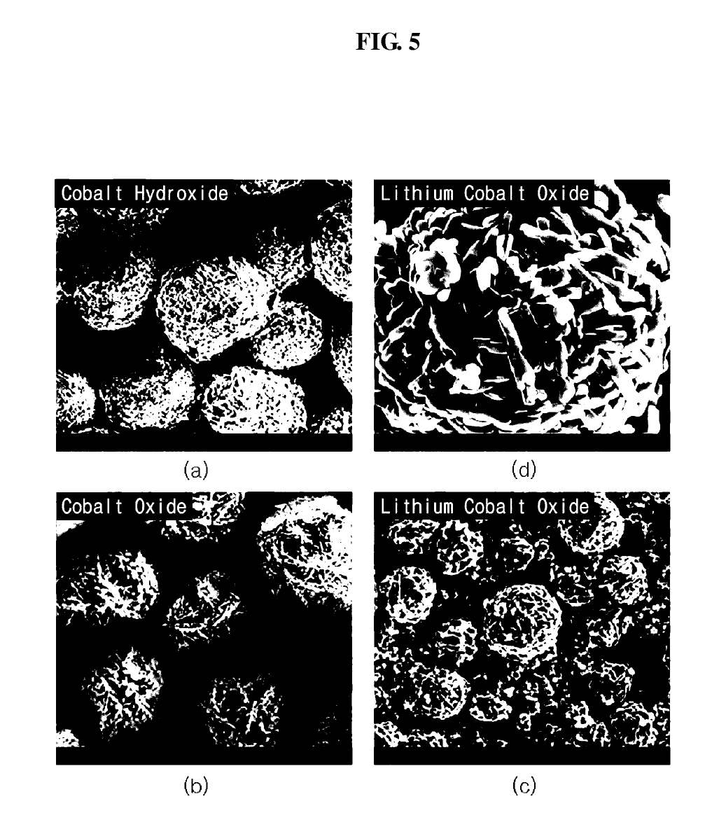

Images of the particle shapes of the cobalt hydroxide, cobalt oxide and lithium cobalt oxide cathode materials prepared by the preparation method of Example 2 are shown in FIG. 5. In Example 2, compared to Example 1, it can be confirmed that density is a little decreased, but compared to Comparative Example 1, it was compared that density and a degree of sphericity are enhanced. FIG. 5(d) is an enlarged image of FIG. 5(c).

It can be confirmed that the cathode material prepared by the preparation method of Example 3, compared to Comparative Example 1, has enhanced density and degree of sphericity as shown in Table 1.

Accordingly, the lithium cobalt oxide prepared from cobalt hydroxide prepared by the preparation method of Example 1 has a high degree of sphericity of 15 to 20 μm, and thus a capacity can be expressed as 85% or more of the initial capacity after charge/discharge 50 times at a high temperature of 60° C. That is, such enhancement in performance of the cathode material is achieved because cobalt hydroxide and cobalt oxide, which have high density and a high degree of sphericity, were prepared using a coprecipitation reaction in a liquid phase by optimizing process conditions, using a functional complex agent, for example, an amine-based material such as ethylenediamine at a higher level than the conventional ammonia solution, and optimizing a content thereof.

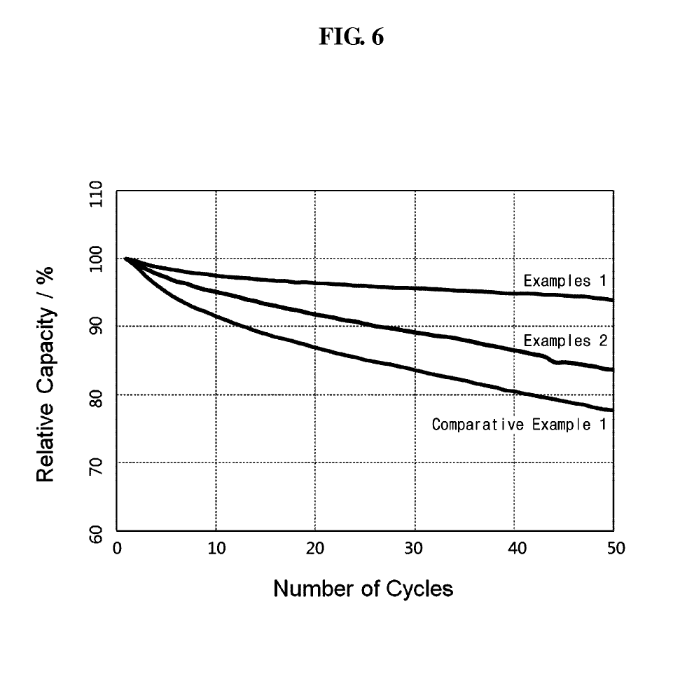

In addition, charge/discharge output characteristics at room temperature of test cells for evaluating an electrode as the cathode materials prepared from the cobalt hydroxide according to Examples 1 and 2 and Comparative Example 1 are measured as shown in FIG. 6. Here, FIG. 6 is a graph showing charge/discharge lifetime characteristics at 60° C. of the cathode materials prepared by the preparation methods of Examples 1 and 2 and Comparative Example 1.

Referring to Table 1 and FIG. 6, it can be confirmed that in Comparative Example 1, compared to Example 1, a decrease in a capacity based on the initial capacity after charge/discharge 50 times is apparently shown. That is, it can be confirmed that the cathode material according to Example 1 has excellent charge/discharge characteristics at a high temperature of 60° C., compared to the cathode material according to Comparative Example 1.

From FIG. 6, with the cathode material according to Example 1, it can be confirmed that the lifetime characteristics at a high temperature of 60° C. are maintained at 93% of the initial capacity after charge/discharge 50 times. In addition, it can be confirmed that, in Comparative Example 1, the capacity is maintained at 77% of the initial capacity after charge/discharge 50 times. In addition, it can be confirmed that, in Example 2, the capacity is maintained at 84% of the initial capacity after charge/discharge 50 times. In addition, it can be confirmed in Table 1 that, in Example 3, the capacity is maintained at 80% of the initial capacity after charge/discharge 50 times.

That is, since the cathode material according to Example 1 is prepared from a high density hydroxide having an ultimately high degree of sphericity, it can be confirmed that it is expressed at 80% or more of the initial capacity after charge/discharge at a high temperature of 60° C.

While the invention has been shown and described with reference to certain exemplary embodiments thereof, it will be understood by those skilled in the art that various modifications in form and details may be made therein without departing from the spirit and scope of the invention as defined by the appended claims.

What is claimed is:

1. A non-aqueous cathode material for a lithium secondary battery, comprising:
spherical cobalt hydroxide, which is prepared by coprecipitating an aqueous solution in which a cobalt material, a hydroxide group material, a dissimilar metal material for substitution and an amine-based material are mixed.

2. The battery according to claim 1, wherein the cobalt hydroxide has a composition represented by Co₁₋ₓMₓ(OH)₂ (where 0.00≦x≦0.10, M=Al, Mg or Ti) and an average particle diameter of 15 to 30 μm.

3. The battery according to claim 1, wherein the cobalt hydroxide is prepared by coprecipitating the cobalt material, the hydroxide group material, the dissimilar metal material for substitution and the amine-based material (each having a concentration of 0.5 to 2 M) in a ratio of 1:1.8 to 2.5:0.1 or less: 0.05 to 0.50, and the pH of the mixed aqueous solution is maintained at 10 to 12.

4. The battery according to claim 1, wherein the amine-based material includes ethylenediamine, urea or succinonitrile (SN).

5. The battery according to claim 4, wherein the cobalt material includes cobalt metal, manganese oxalate, manganese acetate, manganese nitrate or manganese sulfate, and the dissimilar metal of the dissimilar metal material includes aluminum (Al), magnesium (Mg), or titanium (Ti).

6. A non-aqueous cathode material for a lithium secondary battery, comprising:
dissimilar metal-substituted spherical cobalt oxide, which is prepared by preparing spherical cobalt hydroxide prepared by coprecipitating an aqueous solution in which a cobalt material, a hydroxide group material, a dissimilar metal material for substitution and an amine-based material are mixed, and performing thermal treatment.

7. The battery according to claim 6, wherein the cobalt hydroxide has a composition represented by Co₁₋ₓMₓ(OH)₂ (where 0.00≦x≦0.10, M=Al, Mg or Ti) and an average particle diameter of 15 to 30 μm.

8. The battery according to claim 6, wherein the cobalt hydroxide is prepared by coprecipitating a cobalt material, a hydroxide group material, a dissimilar metal material for substitution and an amine-based material (each having a concentration of 0.5 to 2 M) in a ratio of 1:1.8 to 2.5:0.1 or less: 0.05 to 0.50, and pH of a mixed aqueous solution is maintained at 10 to 12.

9. The battery according to claim 6, wherein the cobalt oxide has a composition represented by Co_{3-y}M_{y}O₄ (where 0.00≦y≦0.30, M=Al, Mg or Ti) and an average particle diameter of 10 to 25 μm.

10. The battery according to claim 6, wherein the thermal treatment in the preparation of the cobalt oxide is performed at 500 to 800° C.

11. A non-aqueous cathode material for a lithium secondary battery, comprising:
lithium cobalt oxide, which is prepared by preparing spherical cobalt hydroxide by coprecipitating an aqueous solution in which a cobalt material, a hydroxide group material, a dissimilar metal material for substitution and an amine-based material are mixed, preparing dissimilar metal-substituted spherical cobalt oxide by thermally treating the cobalt hydroxide, mixing a lithium material with the resulting cobalt hydroxide, and performing thermal treatment.

12. The battery according to claim 11, wherein the thermal treatment in the preparation of the cobalt oxide is performed at 500 to 800° C., and the thermal treatment in the preparation of the lithium cobalt oxide is performed at 900 to 1100° C.

13. The battery according to claim 11, wherein the lithium material includes lithium carbonate, lithium hydroxide, lithium acetate, lithium sulfate, lithium sulfite, lithium fluoride, lithium chloride, lithium bromide, or lithium iodide.

14. The battery according to claim 11, wherein the amine-based material includes ethylenediamine, urea or succinonitrile (SN), the cobalt material includes cobalt metal, manganese oxalate, manganese acetate, manganese nitrate or manganese sulfate, and a dissimilar metal of the dissimilar metal material includes aluminum (Al), magnesium (Mg) or titanium (Ti).

15. A non-aqueous cathode material for a lithium secondary battery, which has a composition represented by LiCo_{1-y}M_{y}O₂ (where 0.00≦y≦0.10, M=Al, Mg or Ti), is spherical, and has an average particle diameter of 15 to 25 μm.
